(19) United States
(12) Patent Application Publication
(10) Pub. No.: US 2013/0153646 A1
(43) Pub. Date: Jun. 20, 2013

(54) METHOD FOR SUPPRESSING KIRKENDALL VOIDS FORMATION AT THE INTERFACE BETWEEN SOLDER AND COPPER PAD

(71) Applicant: Cheng-En Ho, New Taipei City (TW)

(72) Inventor: Cheng-En Ho, New Taipei City (TW)

(73) Assignee: YUAN ZE UNIVERSITY, Taoyuan County (TW)

(21) Appl. No.: 13/442,865

(22) Filed: Apr. 10, 2012

(30) Foreign Application Priority Data
Dec. 14, 2011 (TW) 100146221

(51) Int. Cl. B23K 31/02; B23K 1/20

(52) U.S. Cl. 228/256

(57) ABSTRACT

The embodiment of the present invention relates to a method for suppressing Kirkendall voids formation in a solder joint. A solder alloy doped with 0.1˜0.7 weight percent (wt. %) of palladium (Pd) is utilized. Before soldering, the solder alloy is disposed on a copper (Cu) pad, possibly treated with a surface finish. Subsequently, the solder alloy is joined with the Cu pad, so as to form the solder joint with a Cu/Cu₃Sn/(Cu,Pd)₆Sn₅/solder structure. The formation of Kirkendall voids at the Cu/Cu₃Sn interface is greatly suppressed in the presence of Pd in the solder. As the amount of Pd doped is minimal, the properties and the processing conditions for soldering are not changed to a large extent, and the mechanical reliability of the solder joint is significantly improved. Therefore, the present invention is suitable for the microelectronic packaging applications.

### CROSS-REFERENCE TO RELATED APPLICATION

This application claims the priority benefit of Taiwan application serial no. 100146221, filed on Dec. 14, 2011. The entirety of the above-mentioned patent application is hereby incorporated by reference herein and made a part of this specification.

### BACKGROUND OF THE INVENTION

1. Field of the Invention

The present invention relates to a method for enhancing the mechanical reliability of solder joints, and more particularly, to a method for suppressing Kirkendall voids formation at the interface between a solder and a copper pad.

2. Description of Related Art

Soldering is a metallization process, in which two individual components are joined by using a molten solder alloy. Solders used in the microelectronic packages are mostly tin-based alloys, such as tin-lead (Sn-Pb) alloy, tin-zinc (Sn-Zn) alloy, tin-bismuth (Sn-Bi) alloy, tin-indium (Sn-In) alloy, tin-antimony (Sn-Sb) alloy, tin-copper (Sn-Cu) alloy, tin-silver (Sn-Ag) alloy, tin-silver-copper (Sn-Ag-Cu) alloy, tin-silver-bismuth (Sn-Ag-Bi) alloy, and thereof. Solderable pads, which are disposed on the components and are in contact with the molten solder alloy during soldering, are predominately consisted of copper, possibly coated with a surface finish.

During soldering, a liquid-solid reaction (commonly referred to as a soldering reaction) between a solder and a copper pad takes places, and an intermetallic compound (IMC) layer(s) forms at the solder/pad interface. As far as soldering reaction is concerned, Cu₃Sn and Cu₆Sn₅ are the two IMC layers that are usually found at the Cu/solder interface. Previous studies have shown that, when in the normal life use or during a solid-state aging, the copper atom (or copper ion) is the dominant diffusing species in growth of the Cu₃Sn phase. The difference in the intrinsic diffusivities of Cu and Sn in the Cu₃Sn tends to induce the so-called Kirkendall effect, causing vacancies to agglomerate into microvoids (or Kirkendall voids) at the Cu/Cu₃Sn interface through nucleation and subsequent growth. The Kirkendall voids might propagate with the growth of Cu₃Sn and provide a crack initiation site in the subsequent drop test, thereby causing a mechanical/electrical degradation of solder joints. Therefore, to reduce the growth of Cu₃Sn as well as that of Kirkendall voids has long been recognized as an important reliability issue in the microelectronic packaging.

### SUMMARY OF THE INVENTION

An embodiment of the present invention, which is very beneficial to the mechanical reliability of the solder joints, is directed to a method for suppressing Kirkendall voids formation at the interface between a solder and a copper pad.

The present invention provides a method for suppressing Kirkendall voids formation at the interface between a solder and a copper (Cu) pad. In this method, a solder is doped with a minor amount of palladium (Pd) first and then the palladium-containing solder is joined to the copper pad, so as to form a solder joint that can suppress the Kirkendall voids formation at the interface between the solder and the copper pad. The solder joint possesses a structure of Cu/Cu₃Sn/(Cu,Pd)₆Sn₅/solder. The Kirkendall voids primarily form at the Cu/Cu₃Sn interface.

In one embodiment of the method, the amount of palladium for doping the solder is, for example, in a range between 0.1 wt. % to 0.7 wt. % based on the total weight of the solder.

In one embodiment of the method, the material of the solder is, for example, tin (Sn), tin-bismuth (Sn-Bi) alloy, tin-lead (Sn-Pb) alloy, tin-copper (Sn-Cu) alloy, tin-silver (Sn-Ag) alloy, tin-silver-copper (Sn-Ag-Cu) alloy, or any combination thereof.

In one embodiment of the method, the material of the copper pad is, for example, copper or copper-nickel (Cu-Ni) alloy.

In one embodiment of the method, the copper pad includes a copper substrate and a surface finish disposed on the surface of the copper substrate, for example.

In one embodiment of the method, the surface finish includes an organic solderability preservative (OSP) film or other metal films that are allowable to be removed from the Cu/solder interface during soldering. The metal film can be a silver layer, a tin layer, a gold layer, a palladium layer, a nickel layer (thin nickel type), a platinum layer, or any combination thereof.

In view of the foregoing, in the present invention, a minor amount of palladium is doped into the solder before the solder is joined to the copper pad. The quantity of the Kirkendall voids formed at the interface between the copper pad and the Cu₃Sn layer can be substantially reduced by minor addition of palladium, and the mechanical properties of the solder joints can be significantly enhanced due to the decrease of Kirkendall voids.

Other objectives, features and advantages of the present invention are further disclosed in the description of the present invention, wherein the preferred embodiments of this invention are shown and described simply by using illustration of the best modes suitable for carrying out the proposed performance.

### BRIEF DESCRIPTION OF THE DRAWINGS

FIG. 1 showing the optical microscopies (OM) of the interfacial microstructures between copper pads and solders doped with various palladium contents after soldering and subsequently solid-state aging.

FIG. 2 showing the shear strength of the solder joints as a function of the palladium content in the solder.

FIG. 3 showing the secondary electron images (SEI) of the fracture surfaces for the solder joints (board side) that had experienced an isothermal aging and then was subjected to a high-speed ball shear (HSBS) test.

### DESCRIPTION OF THE EMBODIMENTS

Several remedies have been proposed in the past few years for suppressing Kirkendall voids formation at the interface between a solder and a copper pad. The first method is to deposit an additional metal film over the copper pad as a diffusion barrier that is not allowable to be removed during soldering or subsequently solid-state aging. The second is to fine-tune the interfacial microstructures by doping a certain amount of element(s) into the solder or the copper pad before soldering.

In the first method, the interdiffusion between copper (copper pad) and tin atoms (solder) is prohibited by the diffusion barrier, thereby avoiding the formation of Cu-Sn IMCs and Kirkendall voids at the interface between the copper pad and the solder. The nickel-based metal, such as pure nickel (Ni), nickel-copper (Ni-Cu) alloy, nickel-vanadium (Ni-V) alloy, or nickel-phosphorus (Ni-P) alloy, is realized to be the diffusion barrier material of choice. However, the wettability between the nickel-based metal and the solder is not as good as the copper pad, and oxidation might be produced in the nickel-based metal film. These factors deteriorate the solderability of the nickel-based metal, obstructing its use in the microelectronic packaging. To improve the solderability of the nickel-based metal, an additional surface finish like gold, silver, gold/palladium, or gold/palladium (phosphorus), is usually deposited over the surface of the nickel-based metal for oxidation resistance. Accordingly, the manufacture cost of the microelectronic packages is significantly increased with the adoption of this method. Other disadvantages resulting from the nickel-based metal are described as follows. A thick nickel-based metal layer might hinder the fine-pitch packaging applications due to bridging (or short circuits) effect. This is especially problematic for the pitch of less than 20 μm. Additionally, nickel is a magnetic material and might interference the operation/communication of some electronic devices. It is therefore necessary to decrease the thickness of nickel-based metal as far as possible, to reduce the magnetic effect in a specific application. However, voiding in the joint interface might occur once the nickel-based metal (electroless-type plating) is exhausted completely.

In the alternative method, i.e., to fine-tune the interfacial microstructures by doping a certain amount of element(s) into the solder or the copper pad before soldering, the growth kinetics of IMCs (or the type of IMCs) might be modified due to the additives, thereby indirectly reducing the quantity of the Kirkendall voids formed at the interface between a solder and a copper pad. The suggested additives doped include, for example, iron (Fe), cobalt (Co), nickel (Ni), Zinc (Zn), copper (Cu), and so on. Nevertheless, the addition of iron, cobalt, and nickel produces a thicker Cu₆Sn₅ layer than that without any Pd addition. Intermetallic compounds are generally brittle in nature; therefore, a thick Cu₆Sn₅ layer is detrimental to the mechanical characteristics of the solder joints. On the other hand, zinc is very active (easily oxidized). If a solder contains a certain amount of zinc, concern of corrosion should be further taken into account in the resulting solder joints. Although solders contain high copper concentrations do suppress the Kirkendall voids formation, the melting temperatures of such solders would accordingly increase to a certain extent. Moreover, a significant amount of copper doped into the solder produces a plenty of Cu₆Sn₅ in the solder matrix, which deteriorates the mechanical characteristics of the solder joints. In general, minor addition of iron (Fe), cobalt (Co), nickel (Ni), Zinc (Zn), and copper (Cu) might result in a side effect of degrading the reliability of the solder joints, even though these additives enable to suppress the growth of Cu₃Sn (or Kirkendall voids).

The embodiment of the present invention proposes a method for suppressing Kirkendall voids formation at the interface between a solder and a copper pad. In this method, palladium (Pd) is doped into the solder prior to soldering. The material of the solder is, for example, tin (Sn), tin-bismuth (Sn-Bi) alloy, tin-lead (Sn-Pb) alloy, tin-copper (Sn-Cu) alloy, tin-silver (Sn-Ag) alloy, tin-silver-copper (Sn-Ag-Cu) alloy, or any combination thereof. Additionally, the amount of palladium doped is, for example, in a range from 0.1 wt. % to 0.7 wt. %, basing on the total weight of the solder. A soldering reaction between the palladium-containing solder and a copper pad is then performed, so as to form a solder joint containing various Pd contents. The material of the copper pad is, for example, but not limited to, copper or copper-nickel alloy. In another embodiment, the copper pad may also include a copper substrate that is coated with a surface finish. Common surface finish of the copper pad include an organic solderability preservative (OSP) layer or other metal films that is removable during the soldering process (e.g., silver plating layer, tin plating layer, gold plating layer, palladium plating layer, nickel plating layer (thin nickel type), platinum plating layer, or any combination thereof). The surface finish layer is mainly deposited for oxidation resistance, to prevent the copper pad from being oxidized prior to soldering, thereby improving the reliability of soldering (or wire-bonding) process. The solder joint formed in the above manner possesses a structure of Cu/Cu₃Sn/(Cu,Pd)₆Sn₅/solder. The quantity of the Kirkendall voids formed at the Cu/Cu₃Sn interface decreases significantly during the subsequent thermal treatments as palladium is doped.

In the present invention, a minor addition of palladium (0.1 wt. % to 0.7 wt. %) into the solder can reduce the Kirkendall voids formed at the interface between the copper pad and Cu₃Sn, thereby enhancing the mechanical reliability of the solder joints. Furthermore, since the amount of Pd doped is minor (0.1 wt. % to 0.7 wt. %), the properties and the processing conditions for soldering will not be altered to a large extent. Therefore, the present invention is suitable for the microelectronic packaging process used today.

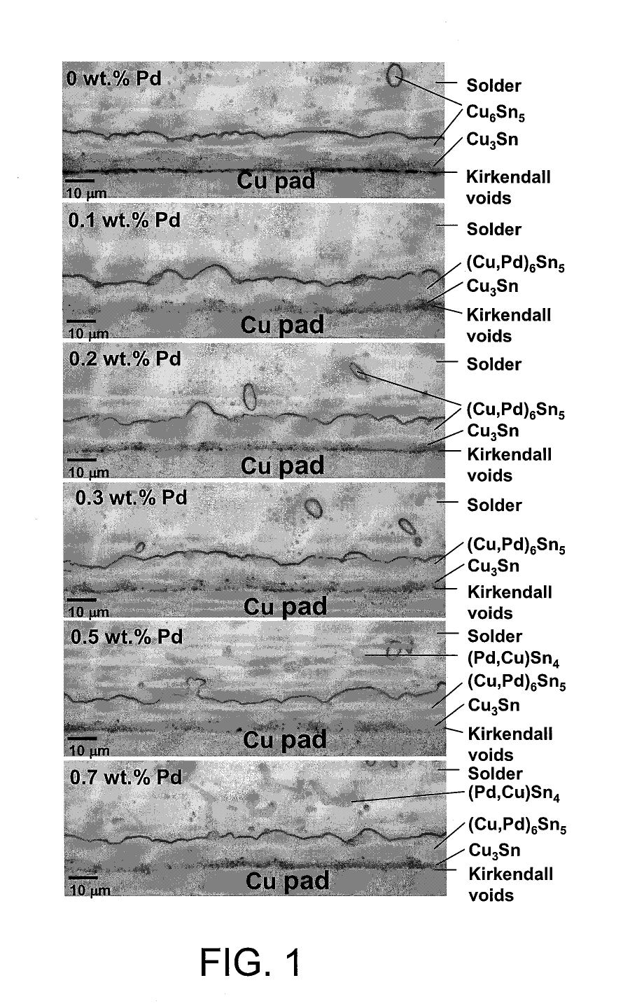

An experimental embodiment is disclosed in conjunction with the present invention. In the experimental embodiment, the solder comprises tin-silver-copper (Sn-Ag-Cu) as the main body. The composition of tin-silver-copper solder is 96.5 wt. % of Sn, 3 wt. % of Ag, and 0.5 wt. % of Cu (commonly referred to as Sn3Ag0.5Cu or SAC305). The above solder is then doped with 0 wt. % (i.e., no palladium is doped), 0.1 wt. %, 0.2 wt. %, 0.3 wt. %, 0.5 wt. %, and 0.7 wt. % of Pd, respectively, and it is shaped into several solder balls with a diameter of 760 μm. The solder balls, which possess different palladium contents, are smeared with a RMA (rosin mildly activated) flux and then are planted onto the copper pads with an opening diameter of 450 μm, correspondingly. Through a typical soldering process, a plurality of solder joints with a Cu/Cu₃Sn/(Cu,Pd)₆Sn₅/solder structure are formed. These solder joints are then subjected to a solid-stage aging treatment for 500 hours at the temperature of 180° C. The solder joints that have gone through the isothermal aging are then submitted to a metallographic examination, such as cross section, grinding, and polishing. The cross-sectional images of the solder joints are shown in FIG. 1.

When the amount of palladium doped into the solder is zero, two IMC layers that grow between the solder and the copper pad are observed after 500 hours of aging, as shown in FIG. 1. The IMC layer adjacent to the solder is identified to be the Cu₆Sn₅ phase, and the alternative layer, which forms between the copper pad and the Cu₆Sn₅ layer, is identified to be Cu₃Sn. The average thickness of the Cu₆Sn₅ layer is approximately 7 μm, and that of the Cu₃Sn layer is approximately 5 μm after the 500-hour aging treatment. In contrast to the Cu₆Sn₅ layer which is formed in the palladium-free joints, the Cu₆Sn₅ layer has approximately 2 at.% of dissolved palladium after aging when the solder is doped with 0.1 wt. %, 0.2 wt. %, 0.3 wt. %, 0.5 wt. %, and 0.7 wt. % of Pd, respectively. Herein, the Cu₆Sn₅ layer in the palladium-containing joints is referred to as (Cu,Pd)₆Sn₅ in the present invention. Moreover, the average thickness of the Cu₃Sn layer is reduced with an increase of palladium content in the solder, and the overall thickness of the IMC layers (i.e., Cu₆Sn₅ and Cu₃Sn) is kept the same after the minor addition of Pd.

It is noteworthy that a chain of Kirkendall voids is produced at the interface between the Cu₃Sn layer and the copper pad in the Pd-free joints (FIG. 1). Interestingly, these Kirkendall voids are significantly reduced by doping Pd into the solder. The results of FIG. 1 demonstrates that the minor addition of palladium can suppress the growth of Kirkendall voids and Cu₃Sn, and the overall thickness of the IMC layers shows no remarkable increment.

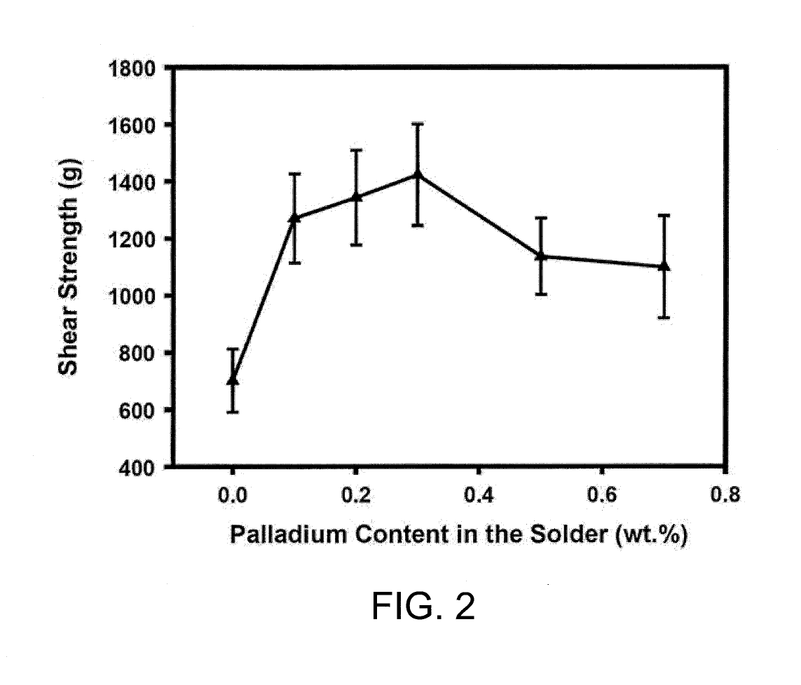

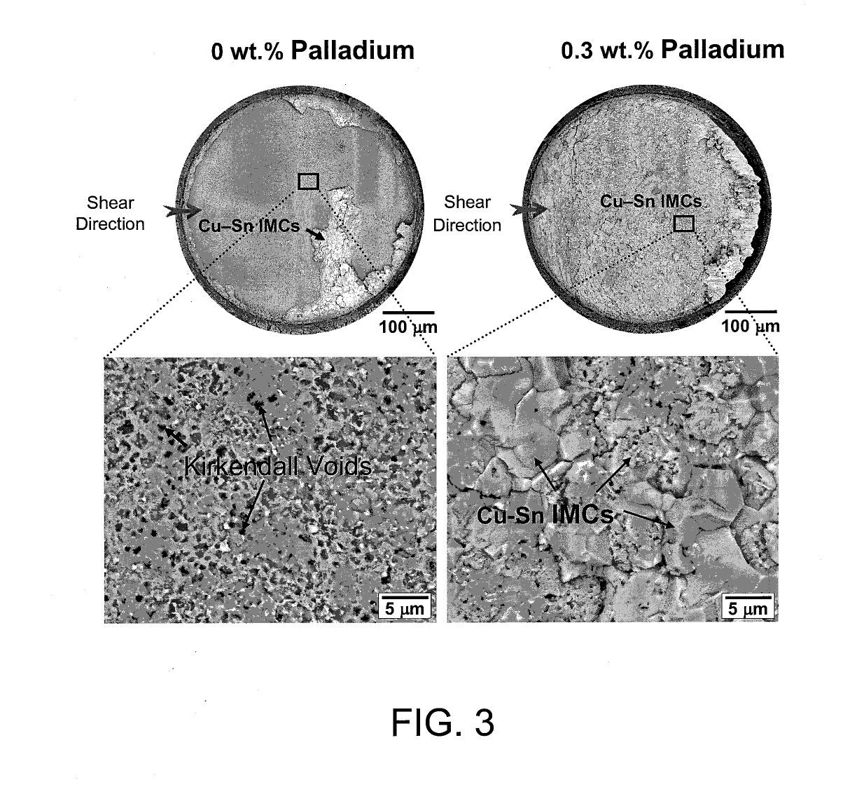

The mechanical test result of the solder joints is presented in FIG. 2. The mechanical properties of the solder joints are evaluated with a high-speed ball shear (HSBS) test at a constant shear speed of 2 m/s. The HSBS test is conducted according to the JESD22-B117 (JEDEC solid state technology association, Edition: 2006) standard. In FIG. 2, the shear strength value increases dramatically as the palladium content in the solder increases in corresponding to the decrease in the quantity of Kirkendall voids, which are formed at the interface between the Cu₃Sn layer and the copper pad after minor addition of palladium (FIG. 1). This inference is further verified by the fracture surface analyses shown in FIG. 3. Referring to FIG. 3, when the solder is not doped with any palladium, the fracture of the solder joint primarily occurs along the interface, between the Cu₃Sn layer and the copper pad, where a large number of Kirkendall voids occupies (FIG. 1). On the other hand, when the solder is doped with Pd (taking 0.3 wt. % of Pd as an example), the quantity of the Kirkendall voids is substantially reduced, and the fracture of the solder joint primarily occurs along the interface between two Cu-Sn IMCs (i.e., Cu₃Sn/Cu₆Sn₅), instead of along the Cu/Cu₃Sn interface as in the Pd-free solder joints. The observation of FIG. 3 indicates that the Kirkendall voids formed at the interface between the copper pad and the Cu₃Sn layer are the root cause of the reduced shear strength values of the solder joints. These results also show that a minor addition of Pd into the solder can effectively reduce the quantity of the Kirkendall voids and the thickness of Cu₃Sn formed at the interface between the solder and the copper pad, thereby enhancing the mechanical reliability of the solder joints.

Overall, in the embodiment of the present invention, a minor amount of Pd is doped into the solder prior to soldering, thus the quantity of the Kirkendall voids formed at the interface between the copper pad and the Cu₃Sn layer is reduced. As a result, the mechanical reliability of the solder joints is improved significantly. Since the amount of Pd doped is quite minimal (0.1 wt. % to 0.7 wt. %), the properties and the processing conditions for soldering are not being altered to a large extent, and the mechanical reliability of the solder joint is significantly improved. Therefore, the present invention is much suitable for the microelectronic packaging applications.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for suppressing Kirkendall voids formation at the interface between a solder and a copper (Cu) pad, comprising:
doping the solder with an amount of palladium (Pd) ranging from 0.1 wt. % to 0.3 wt. % of the total weight of the solder; and
joining the palladium-containing solder to the copper pad, so as to form a solder joint that can suppress the formation of Kirkendall voids at the interface between the solder and the copper pad, wherein the solder joint possesses a structure of Cu/Cu₃Sn/(Cu,Pd)₆Sn₅/solder, and the Kirkendall voids primarily form at the Cu/Cu₃Sn interface.

2. (canceled)

3. The method according to claim 1, wherein the material of the solder comprises tin, tin-bismuth alloy, tin-lead alloy, tin-copper alloy, tin-silver alloy, tin-silver-copper alloy, or any combination thereof.

4. The method according to claim 1, wherein the material of the copper pad includes copper or copper-nickel alloy.

5. The method according to claim 1, wherein the copper pad includes a copper substrate and a surface finish disposed on the surface of the copper substrate.

6. The method according to claim 1, wherein the surface finish comprises an organic solderability preservative (OSP) film.
